(19) United States
(12) Patent Application Publication
(10) Pub. No.: US 2026/0255052 A1
(43) Pub. Date: Aug. 27, 2026

(54) ELECTRONIC DEVICE

(71) Applicant: Panasonic Intellectual Property Management Co., Ltd., Osaka (JP)

(72) Inventors: Shohei KINUTA, Osaka (JP); Toshinari SUO, Osaka (JP); Takayoshi SHIMODA, Osaka (JP)

(73) Assignee: Panasonic Intellectual Property Management Co., Ltd., Osaka (JP)

(21) Appl. No.: 19/545,958

(22) Filed: Feb. 20, 2026

(30) Foreign Application Priority Data
Feb. 25, 2025 (JP) 2025-028160

(51) Int. Cl. H04N 23/60; H04N 23/62; H04N 23/63

(52) U.S. Cl. CPC H04N 23/64; H04N 23/62; H04N 23/631; H04N 23/633

(57) ABSTRACT

An electronic device for managing a plan of image shooting, the electronic device including: a display configured to display information; an input interface configured to receive an input of a user operation; and a controller configured to control the display in accordance with the user operation input in the input interface, wherein the controller is configured to: cause the display to display an illustration area in which illustration information is edited, the illustration information associated with the plan of image shooting; and generate the illustration information by arranging an object in the illustration area, in accordance with the user operation in the input interface, the object representing a subject planned for the image shooting.

### TECHNICAL FIELD

The present disclosure relates to an electronic for managing video shooting in a scenario including a plurality of sections such as cuts.

### BACKGROUND ART

JP 2006-174318 A discloses a video recorder aimed to enable shooting of a video with an excellent storyline and high-level of completion, without increasing troublesome operations in the shooting. The video recorder includes scenario data retaining means for retaining scenario data including shooting guidance information for each one of continuous parts of a video, and display means for displaying, at the time of shooting each scene of the video, the shooting guidance information for the scene included in the scenario data. JP 2006-174318 A intends to allow a videographer to intuitively recognize a composition of a scene, an angle of view, a type of lighting, a camerawork, or a camera movement, by referring to a storyboard, a sketch, an illustration, or a guidance with a photo, included in the scenario data.

### SUMMARY

The present disclosure provides an electronic device and a method that can facilitate illustration for a plan of image shooting.

In the present disclosure, an electronic device is provided for managing a plan of image shooting, the electronic device including: a display configured to display information; an input interface configured to receive an input of a user operation; and a controller configured to control the display in accordance with the user operation input in the input interface, wherein the controller is configured to: cause the display to display an illustration area in which illustration information is edited, the illustration information associated with the plan of image shooting; and generate the illustration information by arranging an object in the illustration area, in accordance with the user operation in the input interface, the object representing a subject planned for the image shooting.

In the present disclosure, a method is provided for managing a plan of image shooting, the method including: causing a controller of an electronic device to display, on a display, an illustration area in which illustration information is edited, the illustration information associated with a plan of image shooting; and generating the illustration information by arranging an object in the illustration area, in accordance with a user operation in an input interface, the object representing a subject planned for image shooting.

According to the electronic device and the method, it is possible to illustration for a plan of image shooting.

### BRIEF DESCRIPTION OF DRAWINGS

FIG. 1 is a diagram illustrating a configuration of an imaging system according to a first embodiment of the present disclosure;

FIG. 2 is a diagram illustrating a configuration of a digital camera in the imaging system;

FIG. 3 is a diagram illustrating a configuration of an information support terminal in the imaging system;

FIG. 4 is a diagram illustrating a display example of a function selection screen in the information support terminal;

FIG. 5 is a diagram illustrating a display example of a scenario input screen in the information support terminal;

FIG. 6 is a diagram illustrating a data structure of cut allocation data in the information support terminal;

FIG. 7 is a flowchart illustrating an operation of a storyboard illustration tool in the information support terminal according to the embodiment;

FIG. 8 is a diagram illustrating a display example of a background editing screen in the information support terminal;

FIG. 9 is a diagram for explaining a layered structure of a canvas area in the information support terminal according to the embodiment;

FIG. 10 is a diagram illustrating a display example of a freehand-editing screen in the information support terminal;

FIG. 11 is a flowchart illustrating character editing processing in the information support terminal;

FIG. 12 is a diagram illustrating a display example of a character editing screen in the information support terminal;

FIG. 13 is a diagram for explaining adjustments of a direction using a direction slider in the information support terminal;

FIG. 14 is a flowchart illustrating template editing processing in the information support terminal;

FIG. 15 is a diagram illustrating a display example of the template editing screen in the information support terminal;

FIGS. 16A and 16B are diagrams for explaining registration of an additional template in the information support terminal;

FIG. 17 is a diagram illustrating a display example of a cut selection screen in the information support terminal; and

FIG. 18 is a diagram for explaining a modification of the digital camera.

### DETAILED DESCRIPTION

Embodiments will be described in detail below with reference to the drawings as appropriate. However, detailed description of already well-known matters and redundant description of substantially the same configuration may be omitted. Note that the accompanying drawings and the following description are provided for those skilled in the art to fully understand the present disclosure, and are not intended to limit the subject matter described in the claims.

### First Embodiment

In a first embodiment of the present disclosure, a system using an electronic device separate from an imaging apparatus that executes video shooting will be described.

### 1. Configuration

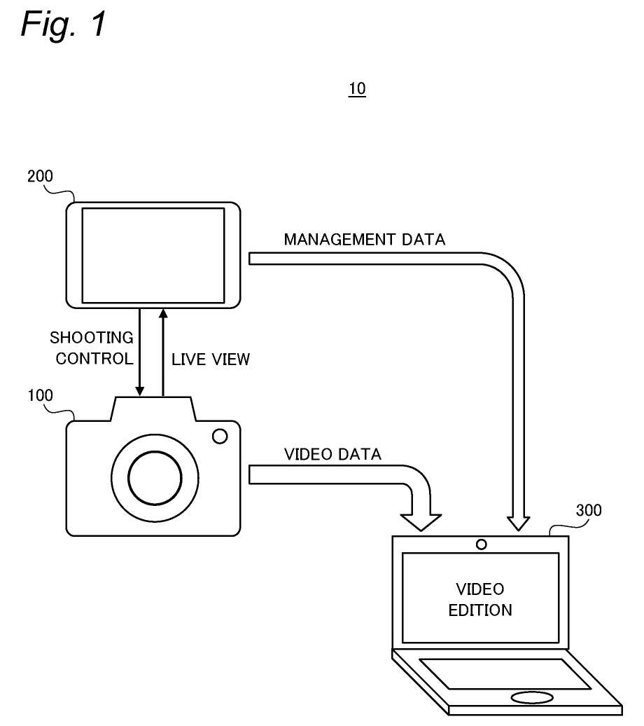

An imaging system according to the first embodiment of the present disclosure will be described with reference to FIG. 1.

For example, as illustrated in FIG. 1, a system 10 includes a digital camera 100, an information support terminal 200, and a video editing personal computer (PC) 300. In the present system 10, the digital camera 100 and the information support terminal 200 are data-communicably connected by wired communication or wireless communication, for example.

The present system 10 is applicable to a user creating a desired video work by shooting and editing a plurality of videos with the digital camera 100, for example. For example, the present system 10 provides information support useful for a series of workflows in which a user plans a scenario indicating a concept of a video work, repeatedly shoot a video according to a plurality of cuts that are divided from the scenario, and edits a plurality of shot videos.

In the present system 10, the information support terminal 200 can manage a scenario of a video work, and control the digital camera 100 so as to manage video shooting for each cut, for example. For example, a live view image in the digital camera 100 can be viewed on the information support terminal 200. The video data of the shooting result of the digital camera 100 is edited in the video editing PC 300. The present system 10 uses data managed by the information support terminal 200 from the viewpoint of facilitating video editing in the video editing PC 300 and the like.

In the present system 10, the video editing PC 300 may or may not be communicably connected to one or both of the digital camera 100 and the information support terminal 200. For example, data from the digital camera 100 and/or the information support terminal 200 may be input to the video editing PC 300 via a portable recording medium such as a memory card. The present system 10 may not include the video editing PC 300.

### 1.1. Configuration of digital camera

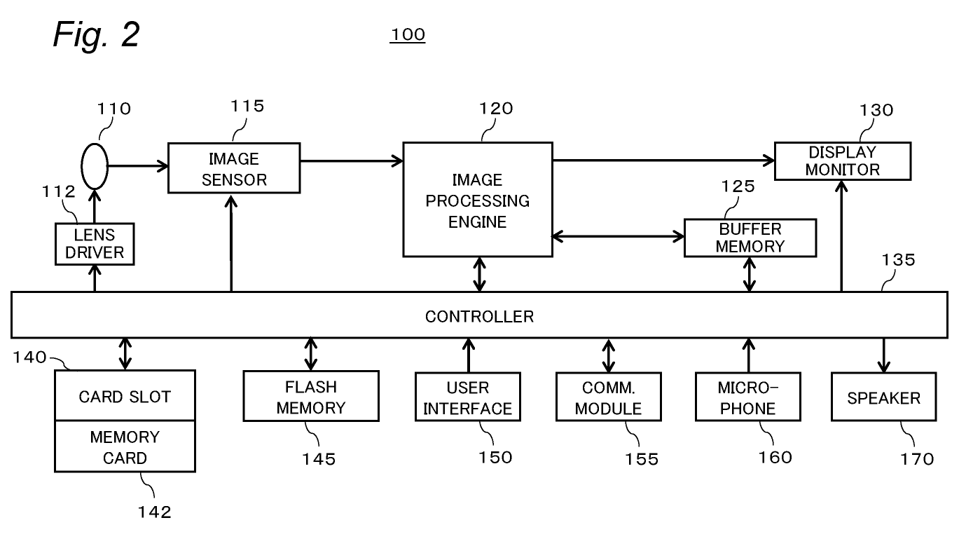

A configuration of the digital camera 100 in the present embodiment will be described with reference to FIG. 2.

FIG. 2 is a diagram illustrating the configuration of the digital camera 100 in the present system 10. The digital camera 100 is an example of an imaging apparatus in the present embodiment. The digital camera 100 according to the present embodiment includes an image sensor 115, an image processing engine 120, a display monitor 130, and a controller 135. Further, the digital camera 100 includes a buffer memory 125, a card slot 140, a flash memory 145, a user interface 150, a communication module 155, a microphone 160, and a speaker 170. Furthermore, the digital camera 100 includes an optical system 110 and a lens driver 112, for example.

The optical system 110 includes a focus lens, a zoom lens, an optical image stabilizer (OIS), an aperture diaphragm, a shutter, and the like. The focus lens is a lens for changing a focus state of a subject image formed on the image sensor 115. The zoom lens is a lens for changing magnification of a subject image formed by the optical system. Each of the focus lens and the like includes one lens or more lenses.

The lens driver 112 drives the focus lens and the like in the optical system 110. The lens driver 112 includes a motor, to move the focus lens along the optical axis of the optical system 110 under the control of the controller 135. The configuration for driving the focus lens in the lens driver 112 can be realized by a DC motor, a stepping motor, a servo motor, an ultrasonic motor, or the like.

The image sensor 115 captures a subject image formed via the optical system 110 to generate imaging data. The imaging data constitutes image data indicating an image captured by the image sensor 115. The image sensor 115 generates image data of a new frame at a predetermined frame rate (e.g., 30 frames/second). The generation timing of the imaging data and an electronic shutter operation in the image sensor 115 are controlled by the controller 135. As the image sensor 115, various image sensors such as a CMOS image sensor, a CCD image sensor, or an NMOS image sensor can be used.

The image sensor 115 performs an operation of capturing a still image, an operation of capturing a through image, and the like. The through image is mainly a video, and is displayed on the display monitor 130 in order for the user to determine a composition for capturing a still image. Each of the through image and the still image is an example of a captured image in the present embodiment. The image sensor 115 is an example of an imager in the present embodiment.

The image processing engine 120 performs various processing on the imaging data output from the image sensor 115 to generate image data, and performs various processing on the image data to generate an image to be displayed on the display monitor 130. Examples of various processing include white balance correction, gamma correction, YC conversion processing, electronic zoom processing, compression processing, expansion processing, and the like, but the various processing are not limited thereto. The image processing engine 120 may be configured by a hard-wired electronic circuit, or may be configured by a microcomputer using a program, a processor, or the like.

The display monitor 130 is an example of a display that displays various information. For example, the display monitor 130 displays an image (through image) indicated by image data captured by the image sensor 115 and subjected to image processing by the image processing engine 120. In addition, the display monitor 130 displays a menu screen or the like for the user to perform various settings on the digital camera 100. The display monitor 130 can be configured by a liquid crystal display device or an organic EL device, for example.

The user interface 150 is a general term for hard keys such as operation buttons and operation levers provided on the exterior of the digital camera 100, operable to receive an operation by the user. For example, the user interface 150 includes a release button, a mode dial, and a touch panel. When the user interface 150 receives an operation by the user, the user interface 150 transmits an operation signal corresponding to the user operation to the controller 135.

The controller 135 integrally controls the entire operation of the digital camera 100. The controller 135 includes a CPU and the like, and the CPU executes a program (software) to realize a predetermined function. The controller 135 may include, instead of the CPU, a processor including a dedicated electronic circuit designed to realize a predetermined function. That is, the controller 135 can be realized by various processors such as a CPU, an MPU, a GPU, a DSP, an FPGA, and an ASIC. The controller 135 may include one or more processors. The controller 135 may include one semiconductor chip together with the image processing engine 120 and the like.

The buffer memory 125 is a recording medium that functions as a work memory of the image processing engine 120 and the controller 135. The buffer memory 125 is realized by a dynamic random access memory (DRAM) or the like. The flash memory 145 is a nonvolatile recording medium. Although not illustrated, the controller 135 may include various internal memories, and may incorporate a ROM, for example. The ROM stores various programs to be executed by the controller 135. The controller 135 may incorporate a RAM that functions as a work area of the CPU.

The card slot 140 is a module into which a removable memory card 142 is inserted. The memory card 142 can be connected to the card slot 140 electrically and mechanically. The memory card 142 is an external memory including a recording element such as a flash memory therein. The memory card 142 can store data such as image data generated by the image processing engine 120.

The communication module 155 is a module (circuit) that connects to an external device according to a predetermined communication standard in wired or wireless communication. For example, the predetermined communication standard includes USB, HDMI (registered trademark), IEEE 802.11, Wi-Fi, Bluetooth, and the like. The digital camera 100 can communicate with other devices via the communication module 155.

The microphone 160 includes one or more microphone elements incorporated in the digital camera 100, for example. The microphone 160 outputs a sound signal indicating the collected sound to the controller 135. An external microphone may be used in the digital camera 100. The digital camera 100 may include a connector such as a terminal connected to an external microphone instead of or in addition to the built-in microphone 160.

The speaker 170 includes one or more speaker elements built in the digital camera 100 and outputs sound to the outside of the digital camera 100 under the control of the controller 135, for example. In the digital camera 100, an external speaker, an earphone, or the like may be used. The digital camera 100 may include a connector connected to an external speaker or the like instead of or in addition to the built-in speaker 170.

### 1.2. Configuration of information support terminal

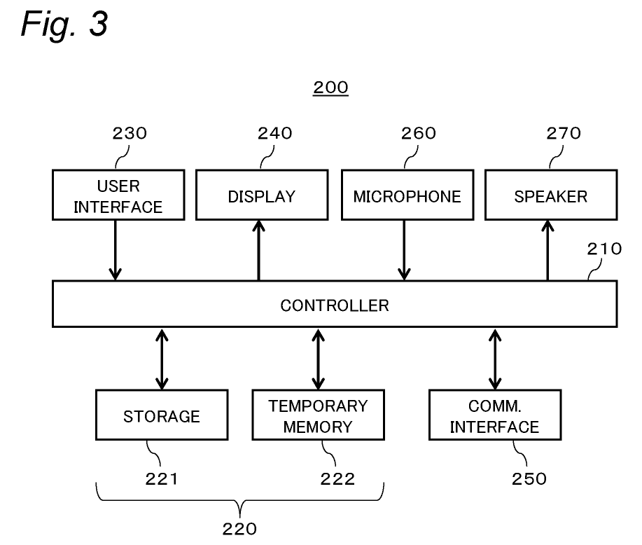

A configuration of the information support terminal 200 in the present embodiment will be described with reference to FIG. 3.

FIG. 3 is a diagram illustrating the configuration of the information support terminal 200. The information support terminal 200 is an example of an electronic device including a smartphone, a tablet terminal, a PC, or the like, for example. The information support terminal 200 illustrated in FIG. 3 includes a controller 210, a memory 220, a user interface 230, a display 240, a communication interface 250, a microphone 260, and a speaker 270.

The controller 210 includes a CPU or an MPU that realizes a predetermined function in cooperation with software, for example. The controller 210 controls the overall operation of the information support terminal 200, for example. The controller 210 reads data and programs stored in the memory 220 and performs various calculation processing to realize various functions.

For example, the controller 210 executes a program including a command group for realizing each of the above-described functions. The above program may be provided from a communication network such as the Internet, or may be stored in a portable recording medium. The controller 210 may be a hardware circuit such as a dedicated electronic circuit or a reconfigurable electronic circuit designed to realize each of the above-described functions. The controller 210 may include various semiconductor integrated circuits such as a CPU, an MPU, a GPU, a GPGPU, a TPU, a microcomputer, a DSP, an FPGA, and an ASIC.

The memory 220 is a memory medium that stores programs and data necessary for implementing the functions of the information support terminal 200. As illustrated in FIG. 3, the memory 220 includes a storage 221 and a temporary memory 222.

The storage 221 stores parameters, data, control programs, and the like for realizing a predetermined function. The storage 221 includes an HDD or an SSD, for example. For example, the storage 221 stores the above-described programs, various image data, and the like.

The temporary memory 222 includes a RAM such as a DRAM or an SRAM, to temporarily store (i.e., hold) data, for example. For example, the temporary memory 222 holds image data in the middle of being edited. In addition, the temporary memory 222 may function as a work area of the controller 210, and may be configured by a storage area in an internal memory of the controller 210.

The user interface 230 is a general term for operation members operated by a user. For example, the user interface 230 is a touch panel superimposed on the display 240 to input various touch operations, and is an example of an input interface of the information support terminal 200. The input interface may be a connection software unit that is communicably connected to various external input devices and receives an operation signal. The user interface 230 may be a physical button, a switch, or the like provided in the information support terminal 200, or a keyboard, a mouse, a touch pad, or the like may be used. The user interface 230 may be various GUIs such as virtual buttons and icons, cursors, software keyboards, and objects displayed on the display 240.

The display 240 includes a liquid crystal display or an organic EL display, for example. The display 240 may display various information such as various GUIs for operating the user interface 230 and information input from the user interface 230.

The communication interface 250 is a module (circuit) that connects to an external device according to a predetermined communication standard in wired or wireless communication. For example, the predetermined communication standard includes USB, HDMI, IEEE 802.11, Wi-Fi, Bluetooth, and the like. The communication interface 250 may connect the information support terminal 200 to a communication network such as the Internet. The communication interface 250 is an example of an input interface that receives various information from an external device or a communication network.

The microphone 260 includes one or more microphone elements incorporated in the information support terminal 200, for example. The microphone 260 outputs a sound signal indicating the collected sound to the controller 210. The information support terminal 200 may include a connector such as a terminal connected to an external microphone instead of or in addition to the built-in microphone 260.

The speaker 270 includes one or more speaker elements built in the digital camera 100, and outputs a sound to the outside of the information support terminal 200 under the control of the controller 210, for example. The information support terminal 200 may include a connector connected to an external speaker, an earphone, or the like instead of or in addition to the built-in speaker 270.

The configuration of the information support terminal 200 as described above is an example, and the configuration of the information support terminal 200 is not limited thereto. For example, various display devices such as a projector and a head mounted display may be used as the display 240 of the information support terminal 200. For example, when an external display device is used, the display 240 of the information support terminal 200 may be an output interface circuit such as a video signal conforming to the HDMI standard or the like.

### 2. Operation

The operation of the present system 10 configured as described above will be described below.

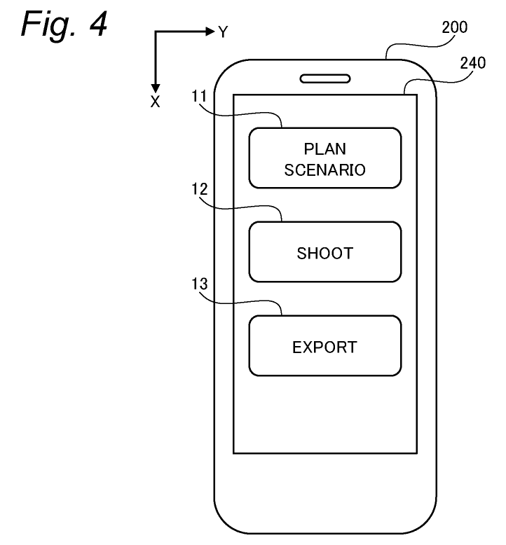

In the present system 10, the information support terminal 200 has various functions for sequentially providing information support to the user in the workflow of video production. A display example of a screen for selecting various functions of the information support terminal 200 is illustrated in FIG. 4.

The display 240 of the information support terminal 200 displays a scenario planning button 11, a shooting button 12, and an export button 13 on the function selection screen illustrated in FIG. 4. Hereinafter, the longitudinal direction on the screen of the display 240 is defined as an X direction, and the width direction is defined as a Y direction.

The scenario planning button 11 is a virtual button that responds a user operation to execute a function (i.e., a scenario planning function) of performing information support for a process of planning a scenario by the user before shooting a video in the present system 10. The information support terminal 200 of the present system 10 manages various information for each cut such as a shooting section that divides the scenario planned in this way. The cut constitutes a section in a plurality of times of video shooting for a scenario, for example.

For example, the shooting button 12 is a virtual button for executing a function (i.e., a cut shooting function) of supporting video shooting of each cut in a scenario planned by the scenario planning function. The number of times of shooting a video for one cut is not particularly limited to one take, and may be a plurality of takes. In the present embodiment, the information support terminal 200 controls video shooting by the digital camera 100 in the cut shooting function, and manages an shooting result for each cut.

The export button 13 is a virtual button for executing a function (i.e., an export function) of performing pre-processing for external output on a management result of video shooting by the cut shooting function and outputting the result. The pre-processing by the export function provides information support for facilitating a process of editing a video of a plurality of shooting results according to a scenario in the video editing PC 300, for example.

The information support terminal 200 of the present system 10 can provide comprehensive information support from planning of a scenario to pre-processing of video editing when the user sequentially uses the functions of the scenario planning button 11, the shooting button 12, and the export button 13, for example.

In the present system 10, the function selection screen of the information support terminal 200 may further include a delete button for deleting various data in the information support as described above. For example, the information support terminal 200 may collectively delete the video files of the same scenario in response to the user operation of the delete button.

### 2.1. Scenario planning function

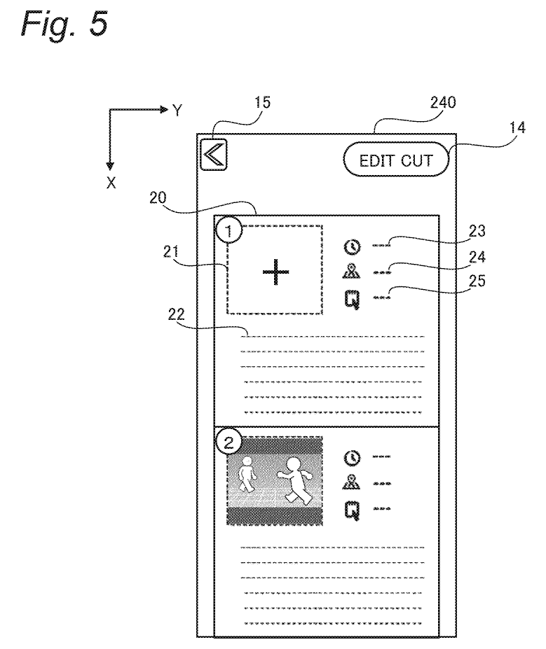

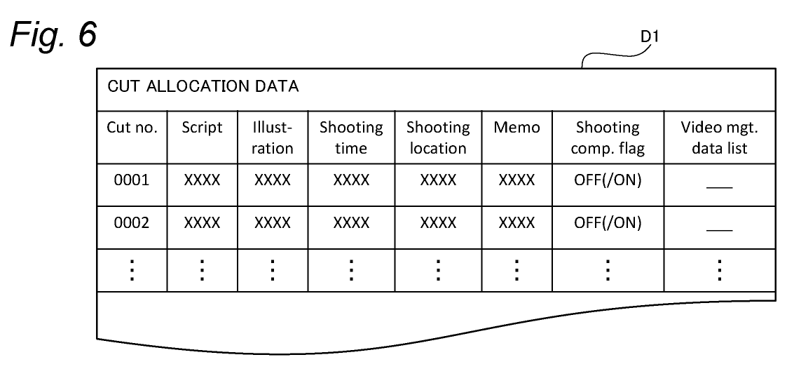

The scenario planning function in the information support terminal 200 of the present system 10 will be described with reference to FIGS. 5 to 6.

FIG. 5 illustrates a display example of a scenario input screen in the information support terminal 200. When a user operation such as tapping the scenario planning button 11 on the function selection screen of FIG. 4 is input from the user interface 230, the controller 210 of the information support terminal 200 displays a scenario input screen on the display 240 as illustrated in FIG. 5.

The scenario input screen is a screen for the user to input a scenario to the information support terminal 200 in the scenario planning function of the present system 10. As illustrated in FIG. 5 the scenario input screen includes a storyboard input field 20 for each cut, a cut edit button 14, and a return button 15, for example. The controller 210 of the information support terminal 200 causes the user interface 230 to receive various user operations related to the scenario input screen displayed on the display 240.

In the information support terminal 200, the storyboard input field 20 receives a user input of information indicating a storyboard such as an outline of a scenario concept for each cut constituting a scenario. As illustrated in FIG. 5 the storyboard input field 20 for each cut includes an illustration field 21, a script field 22, a shooting time field 23, a shooting location field 24, and a memo field 25, for example.

The illustration field 21 receives an input of information of an illustration depicting some idea such as a composition, a development, or a camerawork in shooting the cut of the video. The system 10 provides a tool that assists a user to easily create such an illustration of a cut in the storyboard. In the example illustrated in FIG. 5, any illustration has not been created for the cut with the cut number "1", and an illustration has been created for the cut with the cut number "2". The storyboard illustration tool of the system 10 can facilitate the user to create an illustration for an idea that the user wants to shoot in a given cut, and the user can easily create the storyboard. Details of this tool will be described later.

The script field 22 receives a text input such as a script divided for the cut in the scenario. The shooting time field 23 receives a numerical value input indicating a rough time length for shooting the video of the cut. The shooting location field 24 receives an input of information indicating a location where the video of the cut is shot. The input of the shooting location may be text input, or data search or the like may be appropriately used. The memo field 25 receives an input of various information desired by the user, such as shooting equipment, with respect to the video shooting of the cut by text input, for example.

In the example of FIG. 5, the display 240 displays a storyboard input field 20 for two cuts. The controller 210 acquires the storyboard information for each cut according to the user input to the various fields 21 to 25 in the storyboard input field 20 for each cut in the scenario. On the scenario input screen of the information support terminal 200, the storyboard input field 20 of the cut displayed on the display 240 can be changed according to a swipe operation for scrolling in the X direction in which the storyboard input field 20 for each cut is arranged, for example.

The cut edit button 14 switches on/off of a state in which various user operations such as addition, deletion, and order change of cuts included in the scenario can be input. For example, by a touch operation in the on state of the cut edit button 14, the user can arrange the storyboard input fields 20 for a desired number of cuts in order in time series in the scenario.

The return button 15 responds a user operation to return the screen transition in the information support terminal 200 by one screen. For example, the controller 210 causes the display 240 to transition to the function selection screen (FIG. 4) in response to the user operation of the return button 15 on the scenario input screen (FIG. 5). As an output of such a scenario planning function, the controller 210 according to the present embodiment generates cut allocation data including storyboard information of each cut and stores the cut allocation data in the memory 220. The cut allocation data at the end of such a scenario planning function is illustrated in FIG. 6.

For example, as illustrated in FIG. 6, cut allocation data D1 manages “script”, “illustration”, “shooting time”, “shooting location”, “shooting completion flag”, and “video metadata list” in association with each other for each “cut number”. The cut allocation data D1 is an example of management information in the present embodiment.

For example, the controller 210 of the information support terminal 200 assigns cut numbers indicating cut identification information in the cut allocation data D1 in ascending order in the storyboard input field 20 for each cut arranged on the scenario input screen. When the cut order is changed, the controller 210 re-assigns the cut numbers according to the changed order. For each cut, the controller 210 records each piece of information input to the script field 22, the illustration field 21, the shooting time field 23, the shooting location field 24, and the memo field 25 of the storyboard input field 20 in “script”, “illustration”, “shooting time”, “shooting location”, and “memo” of the cut allocation data D1, respectively.

In the cut allocation data D1, the “shooting completion flag” manages whether the cut is in a state of imaging completion or in a state of imaging incompletion by ON/OFF. At the end of the scenario planning function, the shooting completion flag is set to OFF for all cuts as an initial setting.

The “video metadata list” is a list for storing metadata of a video shot in association with the cut. At the end of the scenario planning function, the video metadata list is set to an empty value as an initial setting.

As described above, according to the scenario planning function in the information support terminal 200 of the present system 10, by generating the cut allocation data D1 from the user input on the scenario input screen, the information support of the process of planning the scenario of the video work desired by the user for each cut can be performed.

The scenario planning function of the information support terminal 200 is not particularly limited to the above. For example, the information support terminal 200 may receive a user instruction for outputting data of the storyboard information of the scenario input on the scenario input screen using a data format (e.g., PDF format) that can be shared by another device, and perform the data output.

### 2.2. Storyboard Illustration Tool

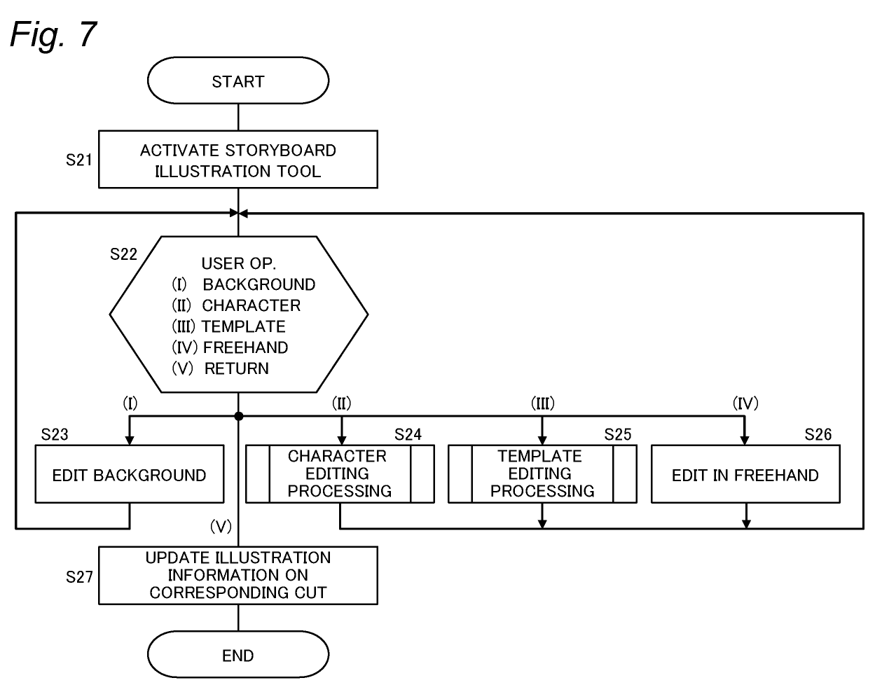

The overall operation of the storyboard illustration tool of the system 10 will now be explained with reference to FIGS. 7 to 10.

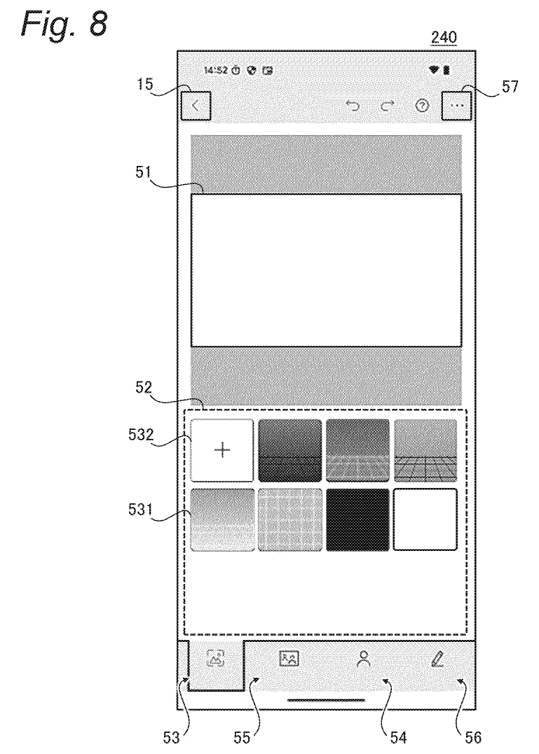

FIG. 7 is a flowchart illustrating an operation of the storyboard illustration tool in the information support terminal 200 according to the present embodiment. The sequence in FIG. 7 is started when the illustration field 21 of the storyboard input field 20 of a cut is operated in the scenario input screen (FIG. 5), for example. Each of the steps included in the flowchart illustrated in FIG. 8 is executed by the controller 210 in the information support terminal 200, for example.

First, the controller 210 activates a storyboard illustration tool (S21). For example, the controller 210 reads the program of the storyboard illustration tool stored in the memory 220, and causes the display 240 to transition from the scenario input screen to an editing screen of the tool. FIG. 8 illustrates a display example of the editing screen of the tool.

In the information support terminal 200 according to the present embodiment, the editing screen of the storyboard illustration tool includes, for example, a canvas area 51, a tool area 52, a plurality of editing tabs 53 to 56, a menu button 57, and a return button 15, as illustrated in FIG. 8. The plurality of editing tabs 53 to 56 include a background tab 53, a character tab 54, a template tab 55, and a freehand tab 56. For example, the information support terminal 200 has a plurality of editing modes that are operation modes corresponding to the respective editing tabs 53 to 56 of this tool, to operate by switching the editing modes in response to a selecting one of the editing tabs 53 to 56 (see S23 to S26).

The canvas area 51 is an area where an illustration of a cut is edited in the display 240, and displays an illustration of the cut under the edition. The canvas area 51 is an example of an illustration area in the present embodiment.

The tool area 52 selectively displays the operation tools such as virtual buttons that are operated in the editing mode corresponding to any of editing tabs 53 to 56, . The information support terminal 200 according to the present embodiment uses a layered structure for defining overlap of objects to be edited on the canvas area 51 in the various editing modes (S23 to S26).

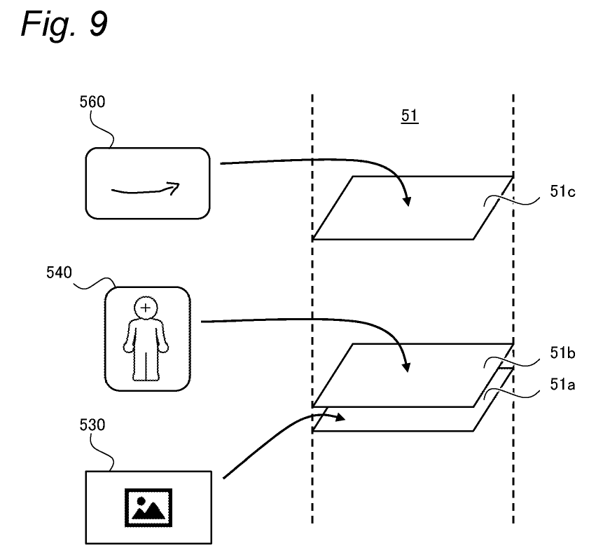

FIG. 9 is a diagram for explaining a layered structure of the canvas area 51 in the information support terminal 200 according to the present embodiment. In the present embodiment, as illustrated in FIG. 9, the canvas area 51 includes a background layer 51a, a character layer 51b superimposed over the background layer 51a, and a freehand layer 51c superimposed over the character layer 51b, for example. The layers 51a to 51c are data areas for arranging, on the canvas area 51, subjects to be edited (530, 540, 560) in the different editing modes respectively (S23 to S26). Illustration information of a cut includes image information resultant of sequentially superimposing the layers 51a to 51c in the canvas area 51 on top of one another.

The controller 210 receives various user operations on the user interface 230, such as a touch panel, with an editing screen, one example of which is illustrated in FIG. 8, being displayed on the display 240 (S21). For example, in step S22, the controller 210 determines which one of the plurality of editing tabs 53 to 56 is selected ((I) to (IV)), or whether the return button 15 is operated ((V)). For example, FIG. 8 illustrates the editing screen with the background tab 53 selected (i.e., a background editing screen), as the initial state of the tool ((I) in S22).

When the background tab 53 is selected ((I) in S22), the controller 210 operates in the background editing mode, which is the editing mode corresponding to the background tab 53, to edit a background image 530 (FIG. 9) in accordance with a user operation performed in the background editing screen as in FIG. 8 (S23). The background image 530 is an image providing the background of the illustration of the cut. As illustrated in FIG. 8, the background editing screen includes a plurality of background buttons 531 and an add button 532 in the tool area 52, for example.

The background buttons 531 are virtual buttons for presenting background images 530 prepared in advance in the tool, for example. In step S23, in response to the user operation on one of the background buttons 531, the controller 210 arranges the corresponding background image 530 in the background layer 51a, to display the image as the background in the canvas area 51, for example (see the cut number "2" in FIG. 5).

The add button 532 is a virtual button for adding a new background image 530. In response to an exemplary operation of the add button 532, the controller 210 receives a user operation of selecting a desired image from the image data stored in the memory 220, to arrange the selected image in the canvas area 51 as the background image 530, in the same manner as described above (S23). The user can store desired image data in the memory 220 in advance, and use the desired image data via the add button 532 in step S23.

In step S23, the controller 210 may adjust the arrangement of the background image 530, e.g., by shifting, rotating, or increasing or decreasing the size of the background image 530 with respect to the canvas area 51 in accordance with a touching operation on the background image 530, for example. The shifting includes various translations, e.g., vertical and horizontal translations of the background image within the canvas area 51, and combinations thereof.

When the character tab 54 is selected ((II) in S22), the controller 210 transitions to the character editing mode, and executes editing processing in accordance with a user operation performed on the character layer 51b (S24). The character editing processing (S24) according to the present embodiment allows the user to make various edits for arranging a desired character 540 in the canvas area 51, as intended by the user. The character 540 is an object (data) representing a subject, such as a character of a scenario, to be shot in the cut. Details of the character editing processing (S24) will be described later.

When the template tab 55 is selected ((III) in S22), the controller 210 transitions to a template editing mode, and executes editing processing that uses a template including a preset arrangement of a character 540 (S25). In the template editing processing (S25) according to the present embodiment, an illustration of a cut is edited using the template such as the preset arrangement of the character 540, or the template itself is edited. Details of the template editing processing (S25) will be described later.

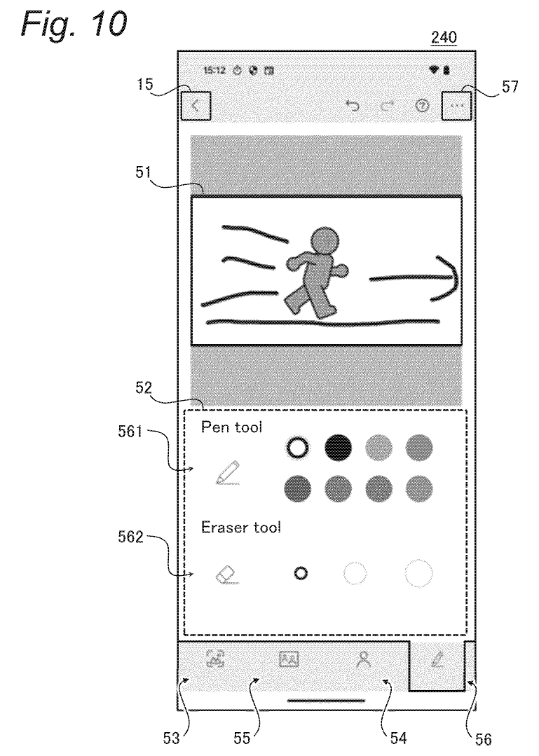

When the freehand tab 56 is selected ((IV) in S22), the controller 210 transitions to the freehand-editing mode, and edits freehand information 560 in accordance with a user operation (S26). The freehand information 560 is an example of additional information arranged in the freehand layer 51c. A display example of the freehand editing screen in step S26 is illustrated in FIG. 10.

In the freehand-editing mode (S26), the controller 210 causes the display 240 to display a pen tool 561 and an eraser tool 562 in the tool area 52, as illustrated in FIG. 10, for example. The pen tool 561 receives a user operation for setting various line types in the freehand information 560, or for enabling an input of the freehand information 560 in the canvas area 51. The eraser tool 562 receives a user operation for deleting input freehand information 560 having been input.

In step S26, responding to a touching operation on the canvas area 51 in the use of the pen tool 561, the controller 210 generates the freehand information 560 provided along the track of the touching operation, to arrange the freehand information in the freehand layer 51c, for example (S26). In response to a user operation made with the eraser tool 562, the controller 210 deletes a part or the whole of the freehand information 560 arranged in the canvas area 51, for example. The controller 210 may decrease or increase the size of the illustration of the cut under the edition, in accordance with a pinch in/out operation on the canvas area 51.

When the return button 15 is operated ((V) in S22), the controller 210 stores the final editing result in the canvas area 51, as an illustration of the cut (S27).

For example, in step S27, the controller 210 generates an illustration of the cut by superimposing and combining the layers 51a to 51c in the canvas area 51 to preserve them at the time when the return button 15 is operated. The controller 210 then stores the illustration of the cut as the result of editing, into the illustration information for the corresponding cut in cut allocation data D1 in the memory 220 (S27). The corresponding cut herein is the cut in the illustration field 21 having been operated at the beginning of the sequence of this flowchart.

When the illustration of the cut as the editing result is saved (S27), the controller 210 stops the tool to end the processing of FIG. 7, for example. The controller 210 then transitions the screen in the display 240 to the scenario input screen, for example. At this time, the controller 210 displays the edited illustration of the cut in the illustration field 21 corresponding to cut, in the scenario input screen.

With the processing described above, the information support terminal 200 according to the present embodiment edits each of the background image 530, the character 540, and the freehand information 560 in the various editing modes of the storyboard illustration tool (S23 to S26), so that the user can easily create an illustration of the cut in the storyboard.

For example, with the layered structure of the tool (FIG. 9), the user can arrange the character 540 in a manner superimposed over the background image 530. The freehand information 560 can be input in a manner superimposed over the background image 530 or the character 540. With the freehand-editing mode (S26) of the tool, the user can edit the freehand information 560, e.g., add the effect lines suggesting the motion of the character 540 arranged in the canvas area 51 in advance, an arrow indicating a camerawork, or hand-written characters.

In the description above, (I) to (V) of step S22 and the like have been explained as examples of user operations received on the editing screen of the tool, but the information support terminal 200 according to the present embodiment is not limited to these particular operations, and may also receive other user operations. For example, the editing screen of the tool may further include a cancel button and a redo button, and the controller 210 may cancel or re-do an edit resultant of a user operation immediately previous to the user operation performed on corresponding one of these buttons.

### 2.2.1. Character Editing Processing

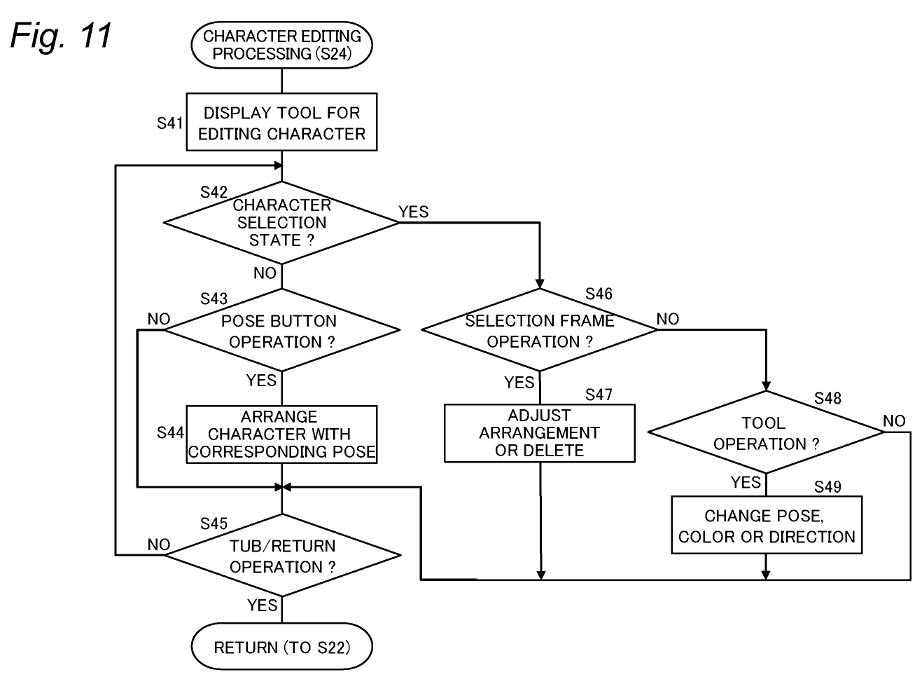

The character editing processing in step S24 in FIG. 7 will now be explained with reference to FIGS. 11 to 13.

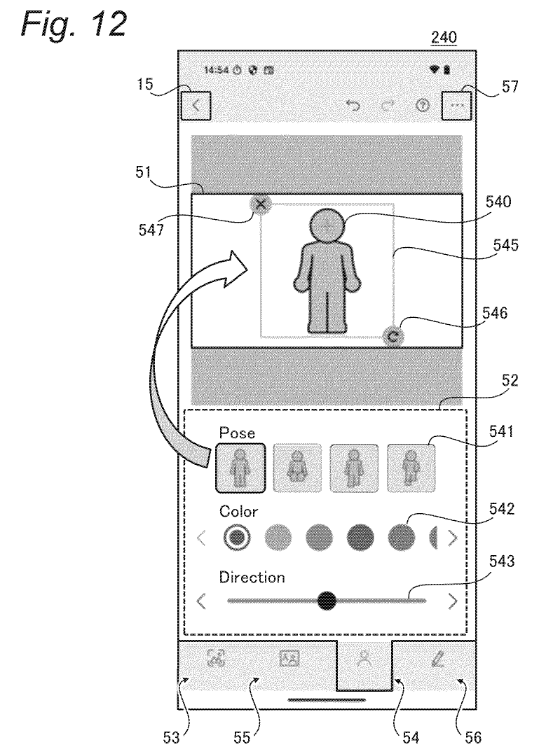

First, the controller 210 causes the display 240 to transition to an editing screen in the character editing mode (S41). A display example in step S41 is illustrated in FIG. 12.

FIG. 12 illustrates a display example of the character editing screen on the information support terminal 200. In the character editing mode, the controller 210 displays a plurality of pose buttons 541, a plurality of color buttons 542, and a direction slider 543, in the tool area 52 (S41), as illustrated in FIG. 12, for example.

Each of the pose buttons 541 presents preset poses for the character 540, as options. These poses are set as appropriate, presuming the use in storyboards. The examples of such poses include a standing pose, a sitting pose, a walking pose, and a running pose. As illustrated in FIG. 12, each of the pose buttons 541 displays a small image of the character 540 in the corresponding pose, for example.

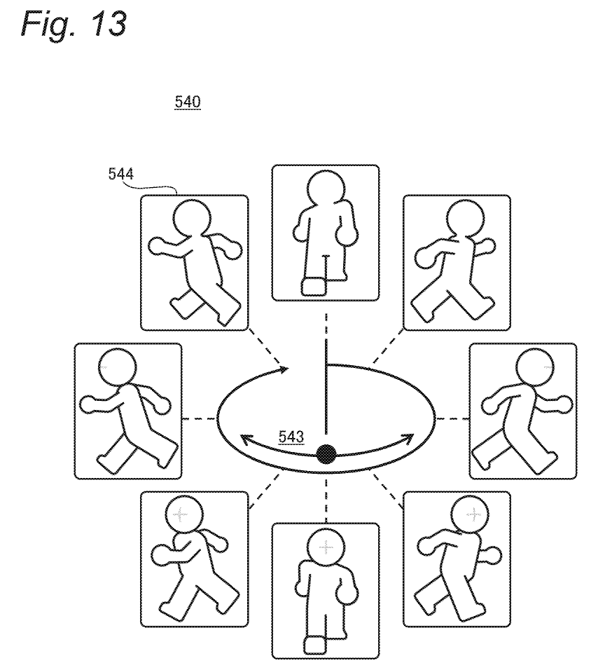

The color buttons 542 receive user operations for selecting a color for coloring the character 540. The direction slider 543 receives a user operation for changing the orientation of the character 540, in directions other than planar rotations in the canvas area 51 (see FIG. 13).

The controller 210 determines whether the character 540 is in a selected state in the canvas area 51, as a result of a user operation in the user interface 230, for example (S42). For example, when no character 540 has been arranged yet in the canvas area 51, as in the initial state, the controller 210 proceeds to NO in step S42.

When the character 540 is not in the selected state in the canvas area 51 (NO in S42), the controller 210 determines whether any of the pose buttons 541 is operated, for example (S43). For example, the user can input an operation of a pose button 541 to the information support terminal 200 by tapping on the pose button 541 corresponding to the desired pose, in the tool area 52.

When the operation of the pose button 541 has been input (YES in S43), for example as illustrated in FIG. 12, the controller 210 arranges the character 540 with the pose corresponding to the operated pose button 541, into the character layer 51b in the canvas area 51 (S44).

For example, a dataset of the character 540 in predetermined poses is stored in the memory 220 in advance, and then the controller 210 reads the shape data corresponding to the pose in step S44. The controller 210 then arranges the character 540, which has the read shape data, at a predetermined initial position in the character layer 51b, for example (S44). In this manner, through a simple user operation of selecting a desired pose from the plurality of pose buttons 541, the user can arrange the character 540 in the selected pose in the canvas area 51.

The controller 210 then determines whether any one of the various editing tabs 53 to 56 and the return button 15 is operated, for example (S45). The controller 210 also proceeds to this step S45 when the operation of none of the pose buttons 541 has been input (NO in S43), for example. When none of the various editing tabs 53 to 56 and the return button 15 has been operated (NO in S45), the controller 210 performs the processing in and after step S42 again, for example.

FIG. 12 illustrates an example of a state where the character 540 arranged in the canvas area 51 is in the selected state (YES in S42). The user can input an operation for selecting the character 540 to the information support terminal 200 by tapping the character 540 in the canvas area 51, for example. Upon proceeding to YES in step S42, the controller 210 displays a selection frame 545 for the character 540 in the selected state, in the canvas area 51, as illustrated in FIG. 12.

The selection frame 545 is displayed in a manner surrounding the character 540, as an example, to indicate that the character 540 is currently in the selected state. Such a selected state of the character 540 is released in response to a touching operation at a position away from the selection frame 545 in the canvas area 51, for example (NO in S42). In response, the controller 210 deletes the selection frame 545 surrounding the character 540 from the canvas area 51.

When the character 540 is currently in the selected state in the canvas area 51 (YES in S42), the controller 210 receives various user operations for the selection frame 545, via the user interface 230, for example (S46). When any user operation for the selection frame 545 has been input (YES in S46), the controller 210 adjusts (or deletes) the arrangement of the character 540 in the canvas area 51, in accordance with the user operation (S47).

For example, in response to a dragging operation of the selection frame 545 (YES in S46), the controller 210 shifts the position of the character 540 currently in the selected state, in the canvas area 51 (S47). As another example, in response to a pinch-in or a pinch-out operation on the selection frame 545 (YES in S46), the controller 210 decreases or increases the size of the character 540 in the canvas area 51 (S47).

The selection frame 545 also includes a rotation button 546 and a deletion button 547, for example, as illustrated in FIG. 12. In response to an operation of the rotation button 546 of the selection frame 545 (YES in S46), the controller 210 rotates the character 540 in the selected state in the canvas area 51 (S47). In response to an operation of the deletion button 547 (YES in S46), the controller 210 deletes the character 540 from the canvas area 51 (S47).

Such an operation for arranging the character 540 inside the canvas area 51 as described above is executable as long as at least a part of the character 540 is within the canvas area 51, for example. For example, in response to a user operation of the selection frame 545 (YES in S46), the controller 210 extracts a part of the image of the character 540 with the part being within the canvas area 51, to display the resultant image (S47). Such image extraction is performed when a part of the character 540 goes out of the canvas area 51, as a result of a user operation such as for enlarging the character 540, for example. After adjusting the arrangement or deleting the character 540 in the selected state (S47), the controller 210 proceeds to step S45, for example.

When no user operation of the selection frame 545 is input (NO in S46), the controller 210 further determines whether any operation of the various buttons 541 to 542 or the direction slider 543 in the tool area 52 is input (S48).

For example, when the pose button 541 is operated with the character 540 being in the selected state (YES in S48), the controller 210 replaces the shape data of the character 540 in the canvas area 51 with the shape data of the pose corresponding to the operated pose button 541 (S49). In this manner, after arranging the character 540 in the canvas area 51, the user can change the pose of the arranged character 540, for example.

When the color button 542 in the tool area 52 is operated (YES in S48), the controller 210 changes the color of the selected character 540 in the canvas area 51, to the color corresponding to the operated color button 542 (S49). For example, by using different colors for the characters 540 corresponding to the respective characters of a desired scenario, the user can easily identify the characters.

When the direction slider 543 in the tool area 52 is operated (YES in S48), the controller 210 performs an editing operation for changing the three-dimensional direction in which the character 540 in the selected state faces, in the canvas area 51 (S49). Such an editing operation (S49) using the direction slider 543 will now be explained with reference to FIG. 13.

FIG. 13 is a diagram for explaining adjustments of the orientation of the character 540, using the direction slider 543 in the information support terminal 200 according to the present embodiment. As an example, the direction of adjustments made with the direction slider 543 is set to the yaw direction (or the line-of-sight direction) of the character 540. For example, the yaw direction is a rotational direction about the vertical axis of the character 540.

With the yaw-direction adjustment using the direction slider 543, positional relations, with which the character is expected in various shooting scenes, can be reproduced easily. Before and after such a direction adjustment, the character 540 has different two-dimensional shapes in the canvas area 51.

For each of such poses of the character 540, the information support terminal 200 according to the present embodiment prepares, in the memory 220 in advance, multiple shape data 544 respectively corresponding to different orientations of the character 540 in the yaw direction, for example as illustrated in FIG. 13. The controller 210 then replaces, in accordance with an operation of the direction slider 543 (YES in S48), the shape data of the character 540 in the canvas area 51 with the shape data 544 corresponding to the orientation resultant of the operation (S49). By changing the orientation of the character 540 in the canvas area 51 selectively, it is possible to implement easy adjustments for the user.

Returning to FIG. 11, after the editing operations (S49) with the various tools 541 to 543 in the character editing mode, the controller 210 proceeds to step S45, for example.

When any input of a user operation on one of the various editing tabs 53 to 56 and the return button 15 is present (YES in S45), the controller 210 ends the character editing processing (S24) illustrated in FIG. 11, to proceed to step S22 in FIG. 7, for example. Note that an operation of the character tab 54 may be excluded from the user operations used as the basis of the determination in step S45. For example, the controller 210 may perform the processing in and after step S42 again in response to an operation of the character tab 54.

With the character editing processing (S24) described above, the information support terminal 200 according to the present embodiment responds to various user operations such as that for arranging the character 540 in the canvas area 51, and can perform various edits on the character 540 in the illustration of the cut (S42 to S49).

In the character editing processing (S24) according to the present embodiment, an edit for arranging a plurality of characters 540 in the canvas area 51 can be made by repeating steps S43 to S44, for example. The tool of the information support terminal 200 may provide a plurality of character layers 51b in the canvas area 51 correspondingly to the arrangement of the plurality of characters 540, for example. The controller 210 can manage overlap between the plurality of characters 540 in the canvas area 51, as appropriate. For example, the descending order of the sizes of the characters 540 or the temporal order of the user operations, such as selections, may be reflected to the order in which the characters are superimposed.

In the above example, the character 540 in the tool has a simple form in which details such as a facial expression are omitted, as illustrated in FIG. 13, for example. Therefore, the same character 540 can be easily used in various illustrations of cuts of a scene to be shot. Additionally or alternatively to the simplified character, the character 540 with details may be used in the tool.

### 2.2.2. Template Editing Processing

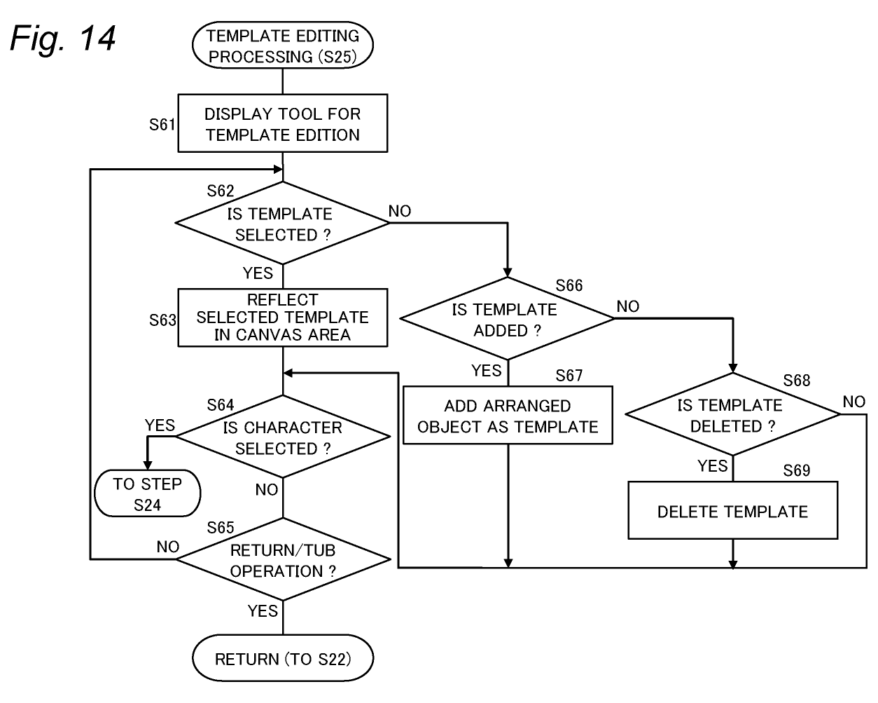

The template editing processing in step S25 of FIG. 7 will now be explained in detail with reference to FIGS. 14 to 16B.

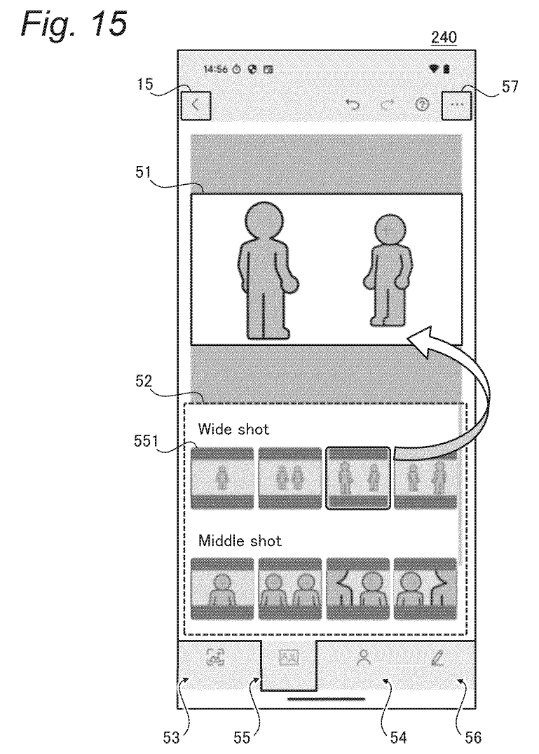

First, the controller 210 causes the display 240 to transition to an editing screen in the template editing mode (S61). A display example in step S61 is illustrated in FIG. 15.

FIG. 15 illustrates a display example of the template editing screen in the information support terminal 200. In the template editing mode, the controller 210 displays a plurality of template buttons 551 in the tool area 52, as illustrated in FIG. 15, for example (S61).

For example, as illustrated in FIG. 15, each of the template buttons 551 displays the image of the corresponding template in a smaller size. Each template button 551 presents, as an option, a template with a preset arrangement of one or more characters 540. In the tool, registration information for each template is stored in the memory 220 in advance.

The templates of the tool are set as appropriate in view of presuming the use for illustrations for cuts in storyboards, and classified into a wide shot corresponding to a wide angle of view, a middle shot corresponding to a medium angle of view, or a tight shot corresponding to a telephoto angle of view, for example. For example, a template in which two characters 540 are allocated side by side or facing each other may be set, presuming a cut with two persons talking.

For example, with selecting a desired template from the tool area 52 where a plurality of template buttons 551 are listed, the user can operate the corresponding template button 551 by making a tap operation or the like. The controller 210 determines whether any operation of one of the template buttons 551 in the tool area 52 is input to the user interface 230, for example (S62).

When the template button 551 is operated (YES in S62), the controller 210 reflects the user-selected template corresponding to the operated template button 551 to the canvas area 51 (S63). For example, the controller 210 arranges one or more characters 540 into the character layer 51b in the canvas area 51 in a manner reproducing the arrangement of the characters 540 in the template corresponding to the template button 551.

When the canvas area 51 has the arranged character 540 before the selection of the template (YES in S62), the controller 210 deletes the arranged character 540 from the canvas area 51 and instead arranges the character in the template, for example (S63). Alternatively, the controller 210 may add, in the canvas area 51, the character of the template without deleting the arranged character 540 (S63).

The controller 210 then determines whether an operation for selecting a character 540 in the canvas area 51 is input to the user interface 230, for example (S64). The user operation used as the basis of the determination in step S64 is the same as those for selecting a character 540 in step S42 (FIG. 11) in the character editing processing described above (S24).

When an operation for selecting a character 540 in the canvas area 51 is input (YES in S64), the controller 210 transitions from the template editing mode to the character editing mode, and proceeds to the character editing processing (S24). At this time, the controller 210 causes the display 240 to transition to the character editing screen (S41), and proceeds to YES in step S42 in FIG. 11, for example.

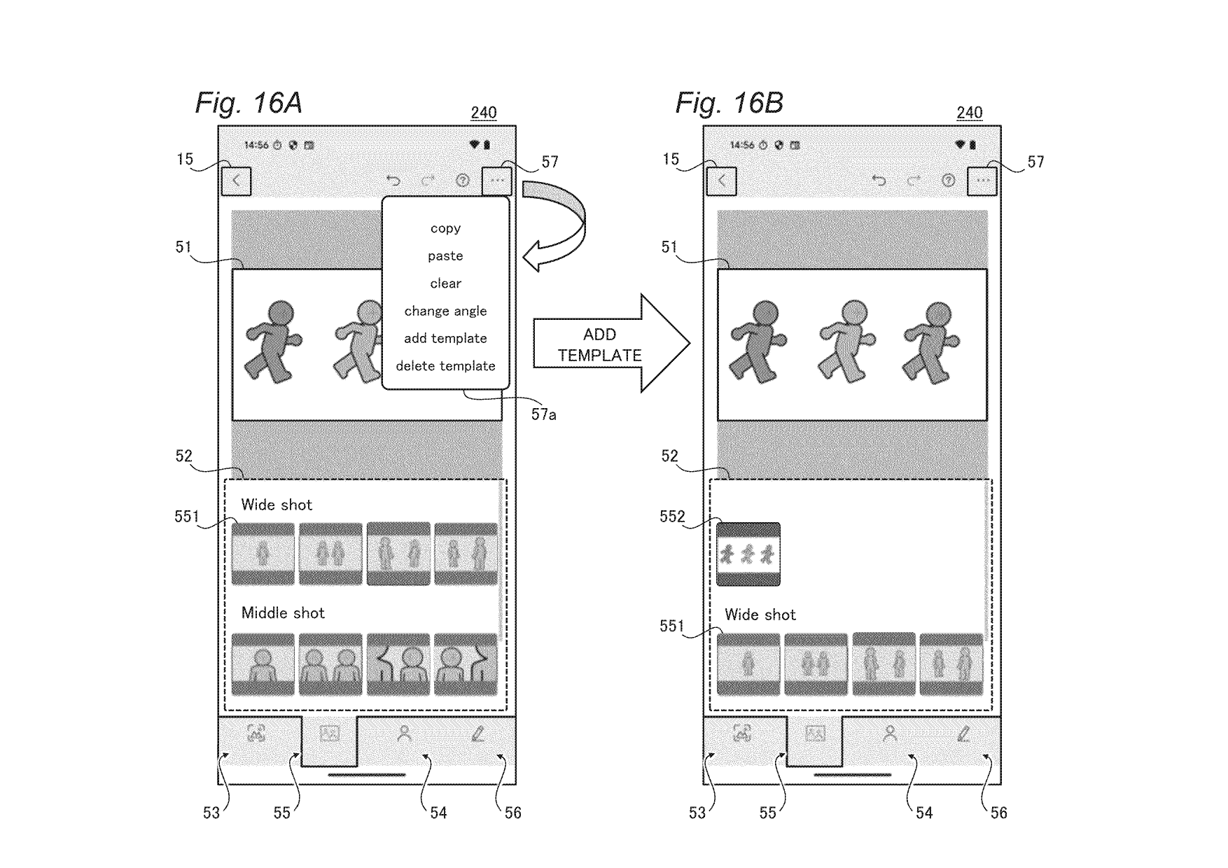

When none of the template buttons 551 is operated (NO in S62), the controller 210 determines whether a user operation for adding a template is input to the user interface 230 (S66). The processing in steps S66 and S67 will now be explained with reference to FIGS. 16A and 16B.

FIG. 16A illustrates a display example of an operation menu 57a in the template editing mode. For example, when a user operation of the menu button 57 is input with the template editing processing being in execution (S25), the controller 210 displays the operation menu 57a, as illustrated in FIG. 16A. The operation menu 57a in this mode includes operation items such as "add template" and "delete template". For example, when the user selects the operation item "add template" from the operation menu 57a, by a tap operation or the like, the controller 210 proceeds to YES in step S66.

When the template adding operation is thus input (YES in S66), the controller 210 additionally registers the current arrangement of the characters 540 in the canvas area 51, as a new template (S67). FIG. 16B illustrates a display example of the display 240 in step S67.

FIG. 16B illustrates a display example of the template editing screen after the additional template is registered (S67) from the state illustrated in FIG. 16A. In step S67, referring to the character layer 51b (FIG. 9) in the canvas area 51 at the template adding operation, the controller 210 extracts various information for the character 540 in the current canvas area 51, for example. The controller 210 then records the extracted information in the memory 220, as registration information of the new template (S67).

Based on the registration information, the controller 210 displays a template button 552 indicating the additionally registered template in the tool area 52 of the template editing mode (S67), as illustrated in FIG. 16B, for example. For example, the registration information in step S67 includes the pose, the orientation, the position, the rotational angle, the size, and the color of each of the characters 540 in the canvas area 51.

Returning to FIG. 14, when no template adding operation is input (NO in S66), the controller 210 determines whether a user operation for deleting a registered template is input to the user interface 230, for example (S68). The template deleting operation in step S68 can be input as user operations of selecting the operation item "delete template" from the operation menu 57a illustrated in FIG. 16A, and then selecting the template button 552 corresponding to the template to be deleted, for example.

When the template deleting operation is input (YES in S68), the controller 210 deletes the registration information of the template corresponding to the selected template button 552, from the memory 220 (S69). The controller 210 also deletes the corresponding template button 552 from the tool area 52 (S69).

The template to be deleted in steps S68 to S69 is limited to additionally registered templates (S66), for example. The template to be deleted (S69) may, however, include other templates, without limitation to the additionally registered templates (S66).

When no template deleting operation is input (NO in S68), the controller 210 proceeds to step S64, for example. The controller 210 proceeds to step S64 also after a template is added (S67) or deleted (S68), for example.

When no operation for selecting a character 540 in the canvas area 51 is input (NO in S64), the controller 210 determines whether any one of the various editing tabs 53 to 56 and the return button 15 is operated, for example (S65). When none of the various editing tabs 53 to 56 and the return button 15 is operated (NO in S65), the controller 210 performs the processing in and after step S62 again.

When a user operation of any one of the various editing tabs 53 to 56 and the return button 15 is input (YES in S65), the controller 210 ends the template editing processing (S25) illustrated in FIG. 14, and proceeds to step S22 in FIG. 7, for example. Note that an operation of the template tab 55 may be excluded from the user operations used as the basis of the determination in step S65. When the template tab 55 is operated, the controller 210 performs the processing in and after step S62 again, for example.

With the template editing processing (S25) described above, the information support terminal 200 according to the present embodiment can use a template in the editing of a character 540 for an illustration of a cut (S62 to S63). The user of the system 10 can easily switch to the editing of a character 540 by a direct operation on the character 540 in the canvas area 51 during the use of the template editing mode (YES in S64).

Note that, in the present embodiment, the mode transitioning to the character editing mode by the user selection of a character 540 in the canvas area 51, as described above, may be limited to the template editing mode, without permitting such a transition to the character editing mode from the background/freehand-editing mode. For example, a user operation on the canvas area 51 with the background editing screen being displayed may be intended to edit the background image 530, rather than a character 540. In such a case, by prohibiting the transition to the character editing mode, various edits are less obstructed so that an illustration of a cut can be created more easily.

With the registration of the additional template in the information support terminal 200 according to the present embodiment (S67), the user can register an additional template when willing to reuse, in the future, the arrangement of the characters 540, having been edited in the canvas area 51, for example. With the template deletion (S68 to S69), the user can timely delete a template registered in the past but no longer in use, for example.

In the information support terminal 200 according to the present embodiment, the information registered for a template in step S67 and the like is not particularly limited to the example described above. For example, the color of the character 540 may be omitted in the registration information of a template. For example, the colors of characters 540 in templates may be unified to a predetermined color (e.g., gray). Alternatively, in step S67, the controller 210 may include information of the background layer 51a or information of the freehand layer 51c in the registration information of the template.

### 2.2.3. Regarding Operation Menu

As illustrated in FIG. 16A, the information support terminal 200 according to the present embodiment includes operation items such as "copy", "paste", "clear", and "change angle" in the operation menu 57a of the storyboard illustration tool, in addition to the items in the example explained above, for example. Such operation items in the tool can be used in various editing modes, without limitation to the template editing mode, by user operations of the menu button 57 similar to that as described above, for example.

For example, when a user operation for selecting the operation item "copy" from the operation menu 57a is input, the controller 210 copies the information on the arrangements in all of the layers 51a to 51c in the current canvas area 51, to store the information temporarily in the memory 220 or the like. For example, such stored information of copies is also retained after the screen is caused to transition to an illustration creation screen for another cut, in response to an operation of the return button 15.

Then, when a user operation on the operation item "paste" is input from the operation menu 57a, the controller 210 arranges the information corresponding to each of the layers 51a to 51c to the canvas area 51, as when the stored information of copies is pasted. For example, the user can use such copy/paste when the user wants to reuse the illustration information of one cut for another cut, in the process of creating the storyboard.

When a user operation of the operation item "clear" is input, the controller 210 deletes the information of all of the layers 51a to 51c in the canvas area 51, to return the canvas area 51 to the initial state, for example. The user can use "clear" when the user wants to delete the various information in the current canvas area 51 entirely, for example.

The operation item "change angle" receives a user operation for changing the range of the canvas area 51 falling within the angle of view, in consideration of the aspect ratio of the video to be shot, for example. For example, the controller 210 presents the user with options of the aspect ratio such as "16:9", "4:3", or "2.35:1", to receive a user operation of selecting one of these options. The aspect ratio option is not limited to the horizontally long aspect ratios as described above, and may include a vertically long aspect ratio such as "9:16". The controller 210 sets the angle of view to the canvas area 51, based on the user setting of the illustration angle of view.

For example, the information support terminal 200 reflects the user setting of the illustration angle of view as described above to the illustration information of all of the cuts in the same storyboard. The system 10 may reflect the aspect ratio setting in a storyboard to the control of the digital camera 100. For example, the controller 210 of the information support terminal 200 may control the aspect ratio of a video when the video is shot using the digital camera 100, by referring to the illustration information included in the cut allocation data D1. The controller 210 may also be configured to notify the user of an alert regarding the relation between the aspect ratio of the video shot by the digital camera 100 and the illustration angle of view in the illustration of the cut.

The information support terminal 200 according to the present embodiment may output an illustration of a cut or information of a storyboard including illustrations of cuts, described above, to the external. For example, the controller 210 can generate storyboard document data in a PDF format or the like, in accordance with a predetermined user instruction, and record the document data in the memory 220 or in an external recording medium, or transmit the document data from the communication interface 250 to an external device. The controller 210 may also output image data of an illustration of a cut, additionally or alternatively to the document data. The information support terminal 200 may permit such a user instruction for external output to be entered via the operation menu 57a or other setting menus.

### 2. 3. Cut shooting function

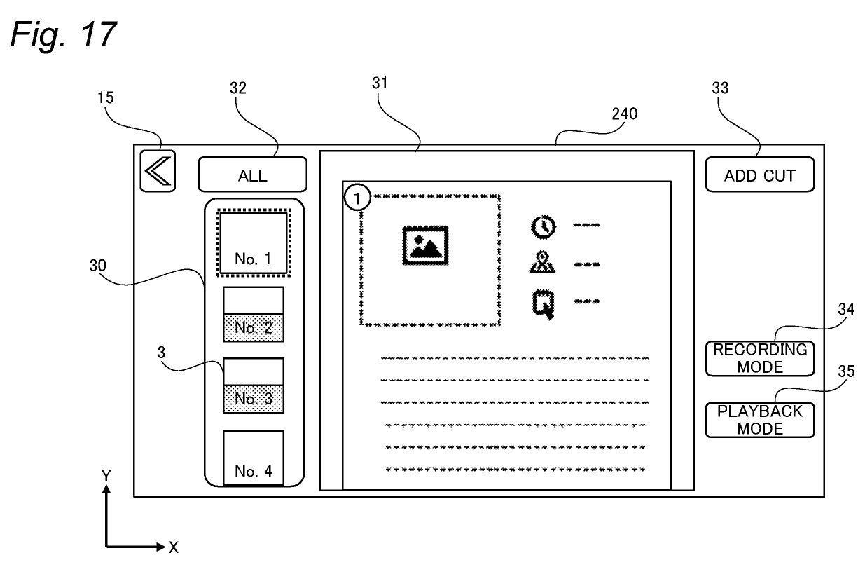

An outline of an operation of the cut shooting function in the information support terminal 200 of the present system 10 will be described with reference to FIG. 17.

FIG. 17 illustrates a display example of a cut selection screen on the information support terminal 200. The cut selection screen is a screen for selecting a cut desired by the user from cuts provided in the scenario planning function in the cut shooting function of the present system 10, for example. The cut selection screen is an example of a selection screen in the information support terminal 200 according to the present embodiment.

As illustrated in FIG. 17, the cut selection screen includes a cut list 30, a storyboard display field 31, a filter button 32, a cut addition button 33, a recording mode button 34, a playback mode button 35, and a return button 15, for example. The cut list 30 is a list listing various cuts as options selectable by the user. The storyboard display field 31 is a display field for displaying storyboard information on the selected cut.

In the cut shooting function of the present system 10, the information support terminal 200 provides information support that facilitates the user to comprehensively carry out video shooting of each cut with checking various cuts, by using the cut selection screen illustrated in FIG. 17, for example. The user may perform video shooting in an order different from the cut order in the scenario, or may perform video shooting of a plurality of takes for video shooting of one cut.

Therefore, the information support terminal 200 of the present system 10 receives the rating by the user of the video for the selected cut at shooting the video of each take, manages whether or not the shooting of the cut is completed, and visualizes the progress status of the video shooting for each cut in the cut list 30 for the user.

As illustrated in FIG. 17 the cut list 30 on the cut selection screen includes a plurality of cut icons 3. Each cut icon 3 indicates an individual cut as an option, for example. Each cut icon 3 may be configured to display a thumbnail image of the illustration of the corresponding cut.

For example, the controller 210 controls the display 240 to highlight the cut icon 3 indicating the selected cut. For example, the highlighting of the selected cut icon 3 is a larger display size than that of the other cut icons 3, a frame enclosure of a highlight color, and the like. Referring to the cut allocation data D1, the controller 210 causes the storyboard display field 31 to display the storyboard information about the cut indicated by the selected cut icon 3.

In the example of FIG. 17, the cut of the cut numbers “1” and “4” is in a state where imaging is not completed, and the cut of the cut numbers “2” and “3” is in a state where imaging is completed. In the cut list 30 according to the present embodiment, the cut icon 3 has a display attribute for identifying a state of imaging completion and a state of imaging incomplete. For example, such a display attribute is set so as to highlight the display mode in which the display mode of the shooting completion state is the imaging incomplete state.

On the cut selection screen according to the present embodiment, each of the cut icons 3 is identified and displayed depending on whether or not the imaging is completed, and thus, it is possible to suppress a situation that a cut is forgotten by a user to shoot. As the identification display of whether or not imaging of each cut is completed is performed so as to reflect the rating of the video of each take by the user, it can be facilitated to ensure the video quality according to the intention of the user. Such rating is performed every time a take is shot, and re-rating can be performed in the playback mode. As a result, it is possible to easily realize quality management of video shooting according to the intention of the user.

### 3. Review

As described above, in the present embodiment, the information support terminal 200 as an example of an electronic device manages the plan of image shooting such as a video shooting including a plurality of cuts. The information support terminal 200 includes a display 240 that displays information, a user interface 230 as an example of an input interface that inputs an operation of a user, and a controller 210 that controls the display 240 in accordance with the operation input on the user interface 230. The controller 210 causes the display 240 to display a canvas area 51, as an example of the illustration area where illustration information of a cut is edited (S21). Illustration information of a cut is an example of graphical information or illustration information associated with a plan of image shooting such as cut shooting. In accordance with a user operation on the user interface 230, the controller 210 arranges a character 540, which is an example of an object representing a subject planned for image shooting, in the canvas area 51, and generates illustration information (S22 to S27).

With the information support terminal 200 described above, it is possible to create an illustration of a cut, with a simple user operation such as arranging a character 540 in the canvas area 51, and to facilitate creating illustration for the plan of image shooting.

In the information support terminal 200 according to the present embodiment, the controller 210 sets a background image 530, as an example of a background in the canvas area 51, in response to a user operation in the user interface 230, and generates illustration information in a manner superimposing an object over the background (S23). As a result, the user can create an illustration of a cut by arranging a character 540 on the background image 530, so that the user can easily create a storyboard, for example.

In the information support terminal 200 according to the present embodiment, the controller 210 receives a user operation for editing freehand information 560 in the user interface 230, as an example of additional information in a layer superimposed over the background and the object in the canvas area 51, and includes the additional information in the illustration information (S26). With this, the user can edit the freehand information 560 in the canvas area 51, so that the user can easily create a storyboard including the freehand information 560.

In the information support terminal 200 according to the present embodiment, the controller 210 adjusts the arrangement of the character 540 in accordance with an operation of the selection frame 545, as an example of a first operation input in a state with an object arranged in the canvas area 51 (S46, S47). As a result, the user can adjust the arrangement of the character 540 in the canvas area 51, so that the user can easily create a desired illustration of a cut.

In the information support terminal 200 according to the present embodiment, the controller 210 switches the pose or orientation of the character 540 in the canvas area 51 in accordance with an operation of a pose button 541 or the direction slider 543, as an example of a second operation input in the state with a character 540 arranged in the canvas area 51 (S48, S49). As a result, the user can easily achieve a wide variety of expression of the character 540 in the canvas area 51, so that the user can easily create a desired illustration of a cut.

In the information support terminal 200 according to the present embodiment, the controller 210 changes the color of the character 540 in the canvas area 51 in accordance with an operation of a color button 542, as an example of a third operation input in the state with a character 540 arranged in the canvas area 51 (S48, S49). The user can then use a color as identification information of a character 540, for example, so that the tool can support creation of a storyboard that is easy to understand.

In the information support terminal 200 according to the present embodiment, the controller 210 causes the display 240 to display template buttons 551 in the tool area 52, as an example of first operation information, and receives a user operation of selecting a template from the first operation information on the user interface 230 (S62). The first operation information represents templates each including a setting of an arrangement of one or more characters 540. The controller 210 arranges one or more characters 540 in the canvas area 51 in accordance with the setting of the selected template (S63). As a result, the user can easily reproduce the arrangement of the character 540 using a desired template, so that the user can easily create an illustration of a cut in the storyboard.

In the information support terminal 200 according to the present embodiment, the controller 210 receives a user operation (S66) for registering a new template in a state where the character 540 is arranged in the canvas area 51, and adds the new template to the first operation information on the basis of the arrangement of the character 540 in the canvas area 51 at the time of the registration, as illustrated in FIGS. 16A and 16B, for example (S67). With this, the user can register an arrangement of a character 540 to be used in the future as a template, so that the user can easily create an illustration of a cut in the storyboard.

In the information support terminal 200 according to the present embodiment, when the first operation information is displayed in the display 240 (i.e., in the template editing mode) and the character 540 in the canvas area 51 is selected in the user interface 230 (YES in S64), the controller 210 causes the display 240 to transition to a state for displaying various tools 541 to 543, as an example of second operation information for editing the character 540 (i.e., the character editing mode), instead of the first operation information. As a result, the user can easily start editing of the character 540 from the template editing screen, so that the user can easily create an illustration of a cut in the storyboard.

In the present embodiment, for example, the controller 210 may be configured not to cause the display 240 to transition to the character editing mode, when the character 540 is selected in a state where third operation information different from the first and second operation information is being displayed in the tool area 52 of the display 240, e.g., in the background or the freehand-editing mode. As a result, it is possible to prevent obstructing a user operation for editing the background image 530 or the freehand information 560 in the canvas area 51, so that the user can easily create an illustration of a cut in the storyboard.

In the present embodiment, the information support terminal 200 further includes a memory 220 that stores cut allocation data D1, as an example of management information for managing a video, in association with each of a plurality of cuts in image shooting. The controller 210 manages the image shooting plan by establishing an association between illustration information and each of the plurality of cuts in the cut allocation data D1 (S27). This tool thus supports creation of a storyboard including a plurality of cuts.

In the present embodiment, the information support terminal 200 further includes the communication interface 250 that performs data communication with the digital camera 100, which is an example of an imaging apparatus that executes image shooting. The controller 210 manages the plan of the image shooting with the imaging apparatus, by data communication via the communication interface 250. As a result, the information support terminal 200 separate from the digital camera 100 can easily manage the video shooting for each cut.

In the present embodiment, a program for causing a processor to operate as the controller 210 in the information support terminal 200 is provided. In the present embodiment, a shooting management method for managing plan of image shooting may also be provided. The method includes a step (S21) of causing the controller 210 of the information support terminal 200 to display, on the display 240, the canvas area 51 where illustration information associated with a plan of image shooting is edited, and a step (S22 to S27) of generating illustration information by arranging a character 540 representing a subject planned for image shooting in the canvas area 51, in accordance with a user operation on the user interface 230. With the shooting management method, the program can support creation of a storyboard, for example, and can support creation of illustration related to a plan of image shooting.

### Other Embodiments

As described above, the first embodiment has been described as an example of the technology disclosed in the present application. However, the technique in the present disclosure is not limited thereto, and can also be applied to embodiments in which changes, substitutions, additions, omissions, and the like are made as appropriate. In addition, it is also possible to combine the components described in the above embodiments to form a new embodiment.

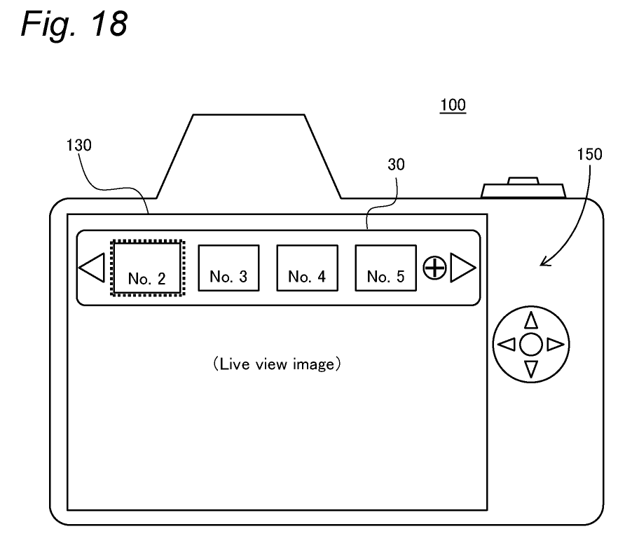

In the first embodiment described above, the information support terminal 200 has been described as an example of an electronic device different from the imaging apparatus, but the present disclosure is not limited thereto. The electronic device according to the present embodiment may be integrated with an imaging apparatus that performs video shooting. Such a modification will be described with reference to FIG. 18.

FIG. 18 illustrates a modification of the digital camera 100. In the present embodiment, the digital camera 100 has various functions such as the above-described scenario planning function and cut shooting function of the information support terminal 200. For example, as illustrated in FIG. 18, the controller 135 of the digital camera 100 displays a cut selection screen including a plurality of cuts by the cut list 30 on the display monitor 130, and receives the cut selection by the user through the user interface 150 such as a touch panel or an operation button.

In the digital camera 100 of the present embodiment, the controller 135 may operate the storyboard illustration tool similar to the first embodiment in the scenario planning function. For example, the controller 135 causes the display monitor 130 to display the editing screen for the illustration of the cut as in the information terminal 200 of the first embodiment, to receive the user operation for the various edits in the user interface 150. Similarly to the information terminal 200 of the first embodiment, the digital camera 100 of the present embodiment can also provide the user with the information support for creating the illustration of the cut.

As described above, in the present embodiment, the digital camera 100 as an example of an electronic device further includes the image sensor 115 as an example of an image sensor that captures a subject image and generates image data. The controller 135 manages the plan of the image shooting by the image sensor 115. Consequently, the digital camera 100 can facilitate illustration for the plan of the image shooting, and thus managing the plan.

In the above embodiments, the imaging system 10 using the information based on the rating of the user has been described, but the present system 10 may not use the rating information of the user. In the above embodiments, the operation example in which the cut allocation data D1 includes a plurality of cuts has been described. However, in the present system 10, the number of cuts of the cut allocation data D1 may be one. In the information support terminal 200 according to the present embodiment, the scenario planning function and the cut shooting function may not be particularly used. Even in such a case, the information support terminal 200 according to the present embodiment can provide the user with the information support for the illustration on the plan of the image shooting.

In the embodiments described above, a character 540 is used as an example of the object, but in the present embodiment, the object is not particularly limited thereto. The storyboard illustration tool according to the present embodiment may also provide objects of types such as "person", "animal", or "vehicle", similarly to the character 540. For the person objects, sub-classifications of objects such as adults or children may also be provided.

In the embodiments described above, the freehand information 560 is used as an example of additional information included in the illustration information of a cut. In the present embodiment, the additional information is not limited to the freehand information 560, and may be a graphic object, such as an arrow, or text information, for example. Additionally or alternatively to the freehand-editing mode (S26), the controller 210 may receive a user operation for arranging a graphic object or inputting a text on the user interface 230.

In the embodiments described above, an example is described where the tool is applied to an illustration of a cut representing a plan of video shooting, in a storyboard. The tool may also be applied to video shooting not using cuts, in particular. The shooting management method according to the present embodiment is not necessarily limited to video shooting, and may manage a plan of still image shooting. Even in such a case, by assisting the creation of illustration information of an idea of a still image or the like that the user wants to shoot, using a tool similar to that described in each of the embodiments, it is possible to assist the creation of illustration for the plan of image shooting.

In the above embodiments, the digital camera 100 including the optical system 110 and the lens driver 112 has been exemplified. The imaging apparatus according to the present embodiment may not particularly include the optical system 110, the lens driver 112, and the like, and may be an interchangeable lens type camera, for example.

In the above embodiments, the digital camera has been described as an example of the imaging apparatus, but the present disclosure is not limited thereto. The imaging apparatus of the present disclosure has only to be an electronic device having an imaging function (e.g., a video camera, a smartphone, a tablet terminal, or the like). The electronic device of the present disclosure does not particularly need to have an image imaging function, and may be various electronic devices.

### Aspect Examples

Hereinafter, various aspects of the present disclosure will be exemplified.

According to a first aspect of the present disclosure, an electronic device that manages a plan of image shooting, the electronic device includes: a display that displays information; an input interface that receives an input of an operation of a user; and a controller that controls the display in accordance with the operation input in the input interface. The controller causes the display to display an illustration area in which graphical information or illustration information associated with the plan of image shooting is edited, and generates the illustration information by arranging an object representing a subject planned for the image shooting, in the illustration area, in accordance with a user operation in the input interface.

According to a second aspect, in the electronic device according to the first aspect, the controller sets a background to the illustration area in accordance with a user operation in the input interface, and generates illustration information in a manner superimposing the object over the background.

According to a third aspect, in the electronic device according to the second aspect, the controller receives a user operation for editing additional information in a layer superimposed over the background and the object in the illustration area, in the input interface, and includes the additional information in the illustration information.

According to a fourth aspect, in the electronic device according to any one of the first to third aspects, the controller is configured to, in accordance with a first operation that is input in a state with an object arranged in the illustration area, adjust arrangement of the object.

According to a fifth aspect, in the electronic device according to any one of the first to fourth aspects, the controller is configured to, in accordance with a second operation input in a state with an object arranged in the illustration area, selectively switch a pose or a direction of the object in the illustration area.

According to a sixth aspect, in the electronic device according to any one of the first to fifth aspects, the controller is configured to, in accordance with a third operation input in the state with an object arranged in the illustration area, change a color of the object in the illustration area.

According to a seventh aspect, in the electronic device according to any one of the first to sixth aspects, the controller causes the display to display first operation information representing templates each including a setting of an arrangement of one or more objects, receives a user operation for selecting a template from the first operation information via the input interface, and arranges one or more objects in the illustration area in accordance with a setting of the template thus selected.

According to an eighth aspect, in the electronic device according to the seventh aspect, the controller receives a user operation for registering a new template in the state with the object arranged in the illustration area, and adds the new template to the first operation information based on the arrangement of the object in the illustration area at the time of registration.

According to a ninth aspect, in the electronic device according to the seventh or eighth aspect, when the object in the illustration area is selected in the input interface in a state where the first operation information is being displayed in the display, the controller causes the display to transition to a state for displaying second operation information for editing the object, in replacement of the first operation information. When an object is selected in a state where third operation information different from the first and second operation information is being displayed on the display, the controller may not cause the display to transition to the state for displaying the second operation information.

In a tenth aspect, the electronic device according to any one of the first to ninth aspects further includes a memory that stores management information for managing shooting of a video including a plurality of cuts, as the image shooting. The controller manages the plan of the image shooting by establishing an association between the illustration information and each of the plurality of cuts in the management information.

In an eleventh aspect, the electronic device according to any one of the first to tenth aspects further includes a communication interface that performs data communication with an imaging apparatus that performs the image shooting. The controller manages the plan of the image shooting using the imaging apparatus, by data communication via the communication interface.

In twelfth aspect, the electronic device according to any one of the first to tenth aspects further includes an image sensor that captures a subject image and generates image data. The controller manages the plan of the image shooting by the image sensor.

A thirteenth aspect is a program for causing a processor to operate as the controller in the electronic device according to any one of the first to the twelfth aspects.

A fourteenth aspect is a shooting management method for managing a plan of image shooting. The method includes a step of causing a controller of an electronic device to display, on a display, an illustration area in which illustration information associated with a plan of image shooting is edited, and a step of generating the illustration information by arranging an object representing a subject planned for image shooting in the illustration area in accordance with a user operation in an input interface.

As described above, the embodiments have been described as an example of the technology in the present disclosure. For this purpose, the accompanying drawings and the detailed description have been provided. Accordingly, some of the components described in the accompanying drawings and the detailed description may include not only essential components for solving the problem but also components which are not essential for solving the problem in order to describe the above technology.

The present disclosure is applicable to various uses for shooting a video including a plurality of cuts.

1. An electronic device for managing a plan of image shooting, the electronic device comprising:
a display configured to display information;
an input interface configured to receive an input of a user operation; and
a controller configured to control the display in accordance with the user operation input in the input interface,
wherein the controller is configured to:
cause the display to display an illustration area in which illustration information is edited, the illustration information associated with the plan of image shooting; and
generate the illustration information by arranging an object in the illustration area, in accordance with the user operation in the input interface, the object representing a subject planned for the image shooting.

2. The electronic device according to claim 1,
wherein the controller is configured to:
set a background to the illustration area in accordance with the user operation in the input interface; and
generate the illustration information with superimposing the object over the background.

3. The electronic device according to claim 2,
wherein the controller is configured to receive the user operation for editing additional information in a layer in the input interface, to include the additional information in the illustration information, the layer superimposed over the background and the object in the illustration area.

4. The electronic device according to claim 1,
wherein the controller is configured to adjust arrangement of the object, according to a first operation that is input with the object arranged in the illustration area.

5. The electronic device according to claim 1,
wherein the controller is configured to selectively switch a pose or a direction of the object in the illustration area, according to a second operation that is input with the object arranged in the illustration area.

6. The electronic device according to claim 1,
wherein the controller is configured to change a color of the object in the illustration area, according to a third operation that is input with the object arranged in the illustration area.

7. The electronic device according to claim 1,
wherein the controller is configured to:
cause the display to display first operation information representing templates, to receive the user operation for selecting a template from the first operation information via the input interface, the templates each including a setting of an arrangement of one or more objects; and
arrange one or more objects in the illustration area in accordance with the setting in the selected template.

8. The electronic device according to claim 7,
wherein the controller is configured to receive the user operation for registering a new template with the object arranged in the illustration area, to add the new template into the first operation information, based on the arrangement of the object in the illustration area at registration.

9. The electronic device according to claim 7,
wherein, in response to selecting the object in the illustration area from the input interface with the first operation information being displayed in the display, the controller is configured to cause the display to transition into a state for displaying, in place of the first operation information, second operation information for editing the object.

10. The electronic device according to claim 1,
further comprising a memory configured to store management information for managing, as the image shooting, shooting of a video including a plurality of sections,
wherein the controller is configured to manage the plan of the image shooting by associating the illustration information with each of the plurality of sections in the management information.

11. The electronic device according to claim 1,
further comprising a communication interface configured to communicate data with an imaging apparatus configured to perform the image shooting,
wherein the controller is configured to manage the plan of the image shooting by the imaging apparatus, based on data communication via the communication interface.

12. The electronic device according to claim 1,
further comprising an image sensor configured to capture a subject image to generate image data,
wherein the controller is configured to manage the plan of the image shooting by the image sensor.

13. A non-transitory computer-readable recording medium storing a program for causing a processor to operate as the controller in the electronic device according to claim 1.

14. A method for managing a plan of image shooting, the method comprising:
causing a controller of an electronic device to display, on a display, an illustration area in which illustration information is edited, the illustration information associated with a plan of image shooting; and
generating the illustration information by arranging an object in the illustration area, in accordance with a user operation in an input interface, the object representing a subject planned for image shooting.
